(19) United States
(12) Patent Application Publication
(10) Pub. No.: US 2011/0196960 A1
(43) Pub. Date: Aug. 11, 2011

(54) METHOD AND DEVICES FOR UPDATING PRESENCE INFORMATION IN A COMMUNICATION NETWORK

(76) Inventors: Christer Boberg, Tungelsta (SE); Anders Lindgren, Alvsjo (SE)

(21) Appl. No.: 12/808,807

(22) PCT Filed: Dec. 18, 2007
(86) PCT No.: PCT/SE2007/051031

§ 371 Date: Jun. 17, 2010

(51) Int. Cl. G06F 15/173

(52) U.S. Cl. 709/224; 709/226

(57) ABSTRACT

The present invention relates to a method and devices for updating presence information in a communication network comprising a first entity and a second entity, in particular a SIMPLE based communication network. The method comprises the steps of: selecting a plurality of services; providing a service element comprising metadata of the plurality of services; providing information within the service element, wherein the information identifies the plurality of services; and sending the service element to the second entity. Further, devices or entities as well as a computer program for performing the method are provided.

### TECHNICAL FIELD

The present invention relates to a method and devices for updating presence information in a communication network. In particular, the present invention relates to updating presence information in an IETF SIMPLE based network employing the Presence Information Data Format (PIDF).

### BACKGROUND

In recent years, communication services in networks have experienced an immense development both in the number of available services, such as online gaming, chatting, etc., as well as the number of users of these services.

In current communication networks that are based on SIMPLE (SIP for Instant Messaging and Presence Leveraging Extensions) a separate presence element (especially a service element) is used to express the status of one single service for a specific user, e.g. that a user is available for playing hearts. Efforts have been made to standardize presence documents and networks employing these. A communication network that is arranged for SIMPLE is described in the Open Mobil Alliance Presence SIMPLE Specification (OMA-TS-Presence_SIMPLE-V1_{—}0_{—}1).

The definition of a service is not explicitly specified but by using one separate service element it is possible to express the status and details of that service separate from other services.

Presence information is exchanged in presence documents that are sent between entities in the communication network, e.g. by employing the Session Initiation Protocol (SIP) described in IETF RFC3261. A common format used for presence documents is the basic Presence Information Data Format (PIDF) specified in IETF RFC3863.

The size of the presence documents exchanged between entities in the communication network is relatively large and the increasing number of services and users lead to a heavy increase in the amount of traffic required between entities in order to update presence data of these services.

Furthermore, networks, and in particular mobile networks, have a limited transmission capacity and the required transmission capacity for update may cause overloading of networks or limit the capacity available for other types of traffic.

### SUMMARY

Accordingly, there is a need for method and devices for increasing the performance of a communication network, in particular a PIDF based communication network.

In order to solve the above-mentioned and other problems, a method for updating presence information in a communication network comprising a first entity and a second entity, is provided, the method comprising the steps of: selecting a plurality of services; providing a service element comprising metadata of the plurality of services; providing information within the service element, wherein the information identifies the plurality of services; and sending the service element to the second entity.

The present invention is in particular intended for use in a presence SIMPLE based communication network, such as an IMS (IP Multimedia Subsystem) and/or an OMA (Open Mobile Alliance) system. However, the present invention may be implemented in any communication system or network employing PIDF.

It is an important advantage of the present invention that the number of presence service elements or tuples is reduced, which leads to a reduced amount of presence data to be sent between entities in the network thereby increasing the performance of the network by a reduction of the required data traffic between entities in the network.

Furthermore, an entity, e.g. a first entity, for a communication network is provided, wherein the entity is adapted for selecting a plurality of services, adapted for providing a service element comprising metadata of the plurality of services, adapted for providing information within the service element, wherein the information identifies the plurality of services, and adapted for sending the service element to another entity in the communication network.

The first entity may be any entity in the network transmitting presence information such as a Presence Source, e.g. a Presence User Agent (PUA), a Presence Network Agent (PNA), or a Presence External Agent (PEA), or a Presence Server (PS). The first entity may be embodied in or run on e.g. a mobile terminal, a PDA, a laptop, a personal computer, an application server or other servers or any other suitable equipment.

In accordance with the present invention, an entity, e.g. a second entity, is provided, which is able to receive and handle presence information that is transmitted according to the method of the present invention. Accordingly, an entity for a communication network is provided, wherein the entity is adapted for receiving a service element comprising metadata of a plurality of services, and adapted for updating metadata of each of the plurality of services based on the received service element.

The second entity may be any entity in the communication network receiving presence information, such as a Presence Server, an Aggregation Proxy, or a Watcher, e.g. an Application Server or a User Equipment. The second entity may be embodied in or run on e.g. a mobile terminal, a PDA, a laptop, a personal computer, an application server or other servers or any other suitable equipment.

Further in accordance with the present invention, a computer program product for updating presence information in a communication network comprising a first entity and a second entity is provided, the computer program product comprising: computer program code which, when run on a computer, can select a plurality of services; computer program code which, when run on a computer, can provide a service element comprising metadata of the plurality of services; computer program code which, when run on a computer, can provide information within the service element, wherein the information identifies the plurality of services; and computer program code which, when run on a computer, can send the service element to the second entity.

It is an advantage of the present invention that the required amount of traffic for updating presence information between entities in a communication network is reduced, which leads to reduced risk of network overload due to presence data update.

The reduction of update traffic is especially important for mobile networks, since the air interface has limited bandwidth and is a resource that may be heavily overloaded.

### BRIEF DESCRIPTION OF THE DRAWINGS

The above and other features and advantages of the present invention will become readily apparent to those skilled in the art by the following detailed description thereof, in particular by detailed description of exemplary embodiments thereof with reference to the accompanying drawings, in which:

FIG. 1 illustrates an embodiment of the method according to the invention,

FIG. 2 schematically illustrates a communication network applying the method according to the present invention,

FIG. 3 schematically illustrates a communication network applying the method according to the present invention,

FIG. 4 illustrates signalling between a Presence Source and a Presence Server in a communication network,

FIG. 5 illustrates signalling between a Presence Server and a Watcher in a communication network,

FIG. 6 partly illustrates an embodiment of the method according to the invention,

FIG. 7 shows a service element employed in an embodiment of the present invention,

FIG. 8 shows a service element employed in an embodiment of the present invention,

FIG. 9 shows a service element employed in an embodiment of the present invention,

FIG. 10 shows a service element employed in an embodiment of the present invention, and

FIG. 11 illustrates update of presence information according to the present invention.

### DETAILED DESCRIPTION

The figures are schematic and simplified for clarity, and they merely show details which are essential to the understanding of the invention, while other details have been left out. Throughout, the same reference numerals are used for identical or corresponding parts.

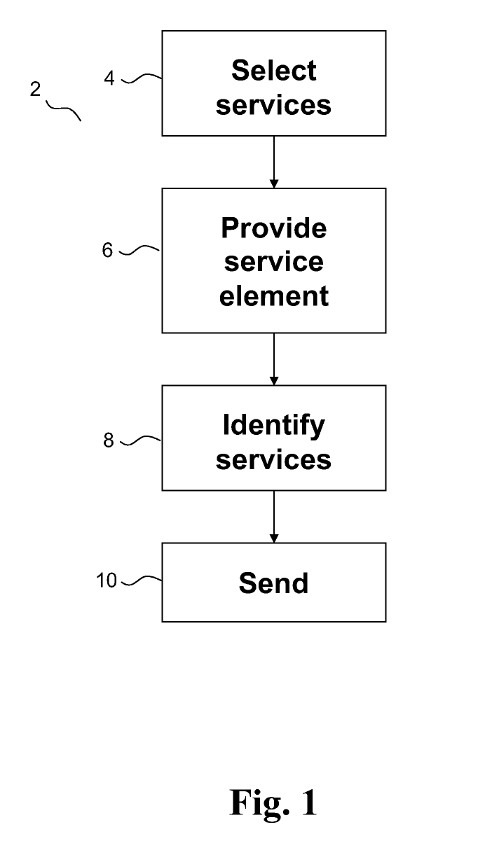

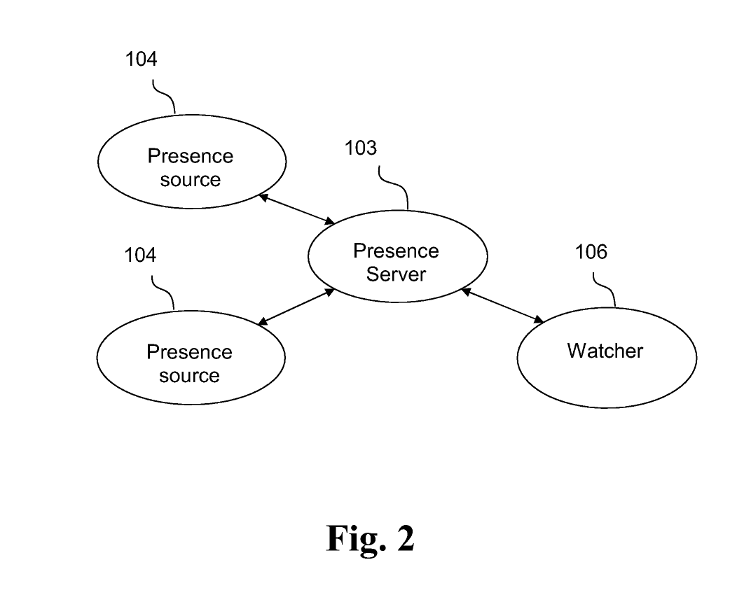

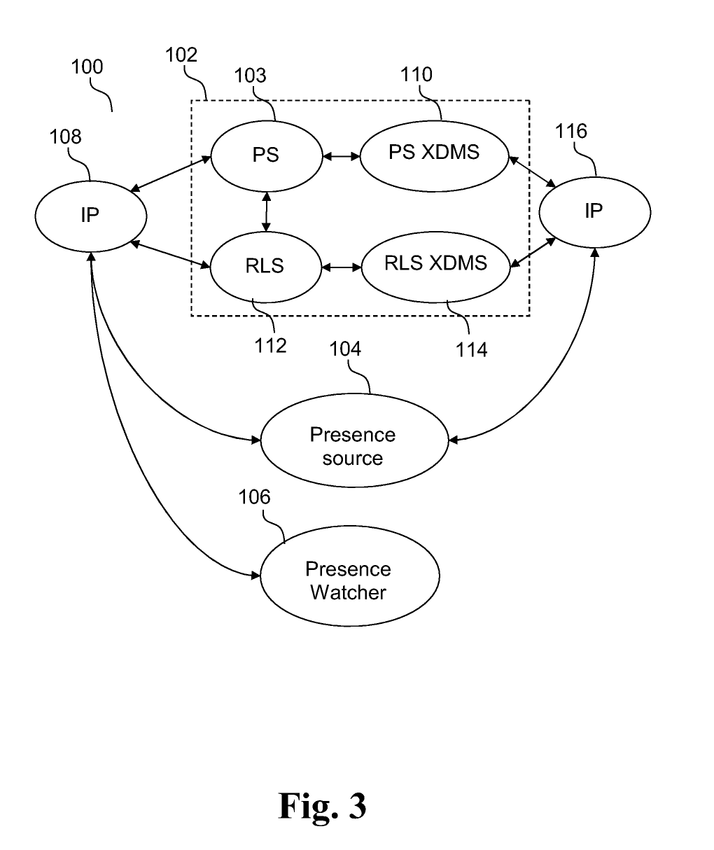

FIG. 1 illustrates an embodiment of the method according to the present invention. The method 2 may be performed in a communication system as schematically illustrated in FIG. 2 or FIG. 3 and comprises the step 4 of selecting a plurality of services. Preferably, step 4 includes selecting a plurality of services having common metadata, e.g. common status and/or common willingness or other types of metadata to be updated. Step 4 may be based on analysis of a plurality of service elements where service elements having identical or partly identical metadata are grouped and subsequently handled according to the steps explained below. After the step 4 of selecting a plurality of services, the method proceeds to step 6 of providing a service element comprising metadata of the plurality of services and subsequently to the step 8 of providing information within the service element. The information within the service element identifies the plurality of services or at least a part of the plurality of services selected in step 4. Steps 6 and 8 may in an embodiment of the present invention be performed in reverse order. Then the method proceeds to step 10, where the service element comprising metadata of a plurality of services and information identifying these services is sent or transmitted to a receiving entity, e.g. a second entity, in the communication network.

The basic concept of the present invention is to create one single service element for a plurality of services having the same presence data, whereby the amount of data that is used to express the presence status of services with similar characteristics may be heavily reduced.

In FIG. 2, a communication network applying the method according to the present invention is schematically illustrated. The communication network is an IETF SIMPLE network comprising a Presence Server 103 communicating with one or more Presence Sources 104 and one or more Watchers 106 as illustrated by the double arrows. The present invention provides a significant reduction in the amount of data sent between entities, e.g. between a Presence Source 104 and the Presence Server 103 and/or between a Presence Server 103 and the Watcher 106, in the communication network during update of presence information in the network.

FIG. 3 schematically illustrates an embodiment of the network in FIG. 2. The communication network 100 is an IMS network applying the method according to the present invention. In the presence IMS network 100, the Presence System 102 comprises the entities Presence Server PS 103, PS XDMS 110, RLS 112, and RLS XDMS 114. The Presence Server 103 communicates with entities comprising Presence Sources 104 and Watchers 106 via IP networks 108, e.g. including a CSCF. Further, a Presence Source 106 may update presence rules and authorizations in the PS XDMS 110, e.g. by sending XCAP messages via IP network 116.

The Presence Server (PS) 103 is an entity that accepts, stores and distributes presence information by handling publications from Presence Source(s) 104 of presentities, composing presence information from Presence Source(s) 104, handling subscriptions from Watchers 106 to presence information, and updating presence information when changes occur. The Presence Server 103 exchanges information with Presence Server XML Document Manipulation Server (PS XDMS) 110 that is a database for storage of documents related to presentities, e.g. subscription authorization rules and presence content rules for watchers. The Presence System 102 may further comprise a Resource List Server (RLS) 112 which accepts and manages subscriptions to presence lists, thereby enabling a Watcher to subscribe to multiple presentities by using only a single subscription transaction. The RLS 112 stores and retrieves presence lists of watchers in the RLS XDMS 114 that is a database for storing presence lists.

The entities in the network 100 are adapted to handle, i.e. send and/or receive, single service elements in presence documents, where each single service element may include information about a plurality of services according to the present invention.

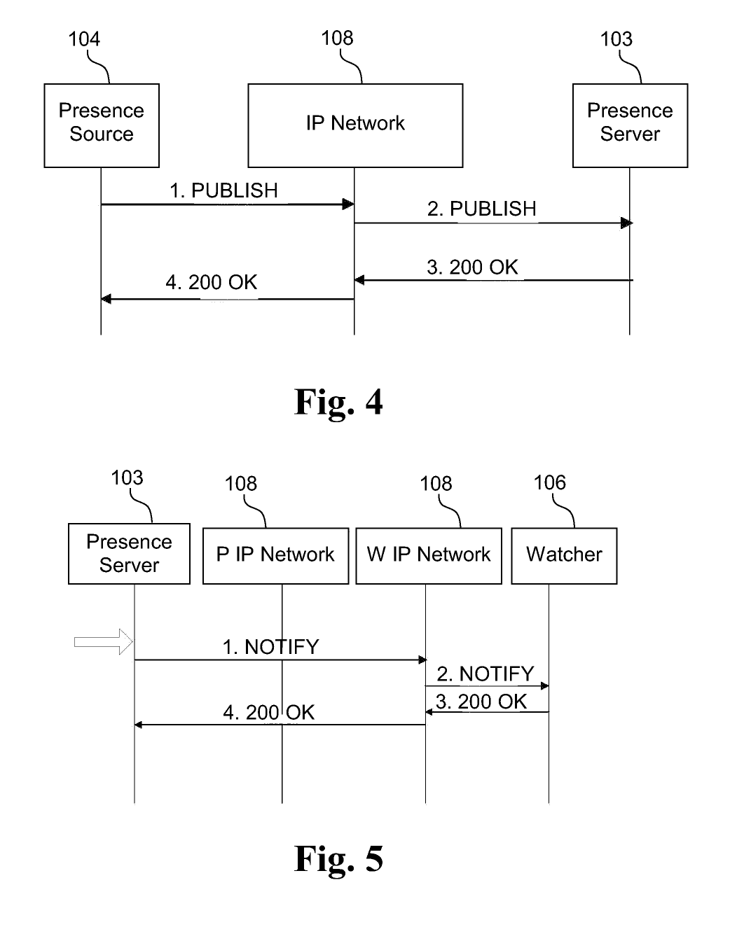

FIG. 4 and FIG. 5 illustrate examples of signaling between a Presence Source 104 and a Presence Server 103 and between a Presence Server 103 and a Watcher 106, respectively, where the method according to the present invention may be applied. The present invention is not limited to these signaling examples, but may be applied to any signaling between any entities in the network exchanging presence information. As illustrated in FIG. 4, the Presence Source 104 sends a SIP PUBLISH message including a presence document comprising a service element that identifies a plurality of services and metadata to be updated to the Presence Server 103 via the IP Network 108 when the Presence Source 104 wants to update presence information for one or more services. According to the invention, a single service element may comprise information identifying a plurality of services thereby saving valuable bandwidth and transmission resources leading to a more efficient communication network. When the Presence Server 103 receives the SIP PUBLISH message, the Presence Server 103 handles the presence document accordingly, i.e. updates relevant registers, and confirms receipt by sending a SIP OK message to the Presence Source 104.

In FIG. 5, the Presence Server 103 sends a SIP NOTIFY message to the Watcher 106 via Watcher IP network 108 when the Presence Server 103 updates presence information for one or more services. The SIP NOTIFY message comprises a presence document including a service element identifying a plurality of services and metadata of the services to be updated. The Watcher 106 receives and handles the presence document and confirms receipt by sending a SIP OK message to the Presence Server 103.

The method may be implemented in a number of ways. Presence data may be embodied in an XML document, e.g. at least partly according to PIDF. Accordingly, the method according to the invention suggests an extension of PIDF which enables more efficient use of bandwidth in communication networks.

In an embodiment of the method according to the present invention, the step of providing information within the service element, wherein the information identifies the plurality of services, may comprise providing at least one service description element, where each service description element comprises at least one service of the plurality of services. In an embodiment of the present invention, a service element comprises one service description element identifying a number of services, such as one, two, three, four, or more services, to be updated, e.g. all services to be updated.

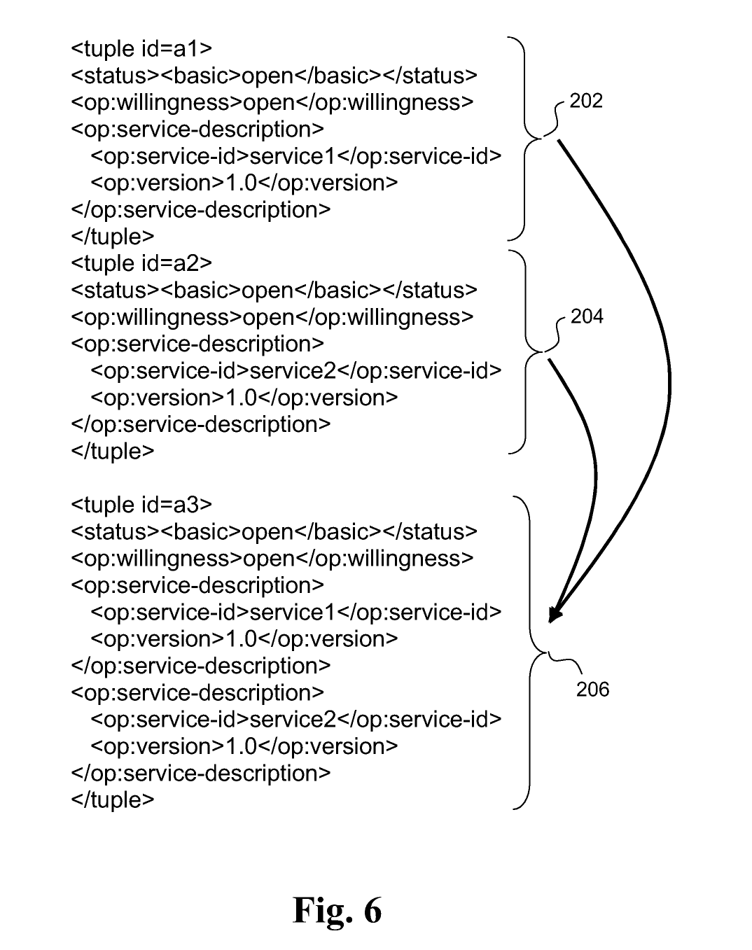

FIG. 6 illustrates collapsing of two service elements 202, 204 into one service element 206 according to the present invention. The service element 202 contains information about the service “service1” whose metadata are to be updated with status=open and willingness=open. The service element 204 contains information about the service “service2” whose metadata are to be updated with the same metadata as service1, i.e. status=open and willingness=open. An entity wanting to update the services “service1” and “service2” having common metadata are selected or identified, and a service element 206 having the common metadata status=open and willingness=open is provided, e.g. in a XML presence document. Further, the entity provides information within the service element 206, the information identifying the two services “service1” and “service2”. In the embodiment illustrated in FIG. 6, a service description element is included in the service element 206 for each service to be updated, i.e. the service element 206 comprises two service description elements with a separate service id element for each service.

One or more services may be identified in a description element and/or in a service-id element within the one or more service description elements of a service element.

Further, the at least one service description element may comprise a list element identifying one or more services of the plurality of services.

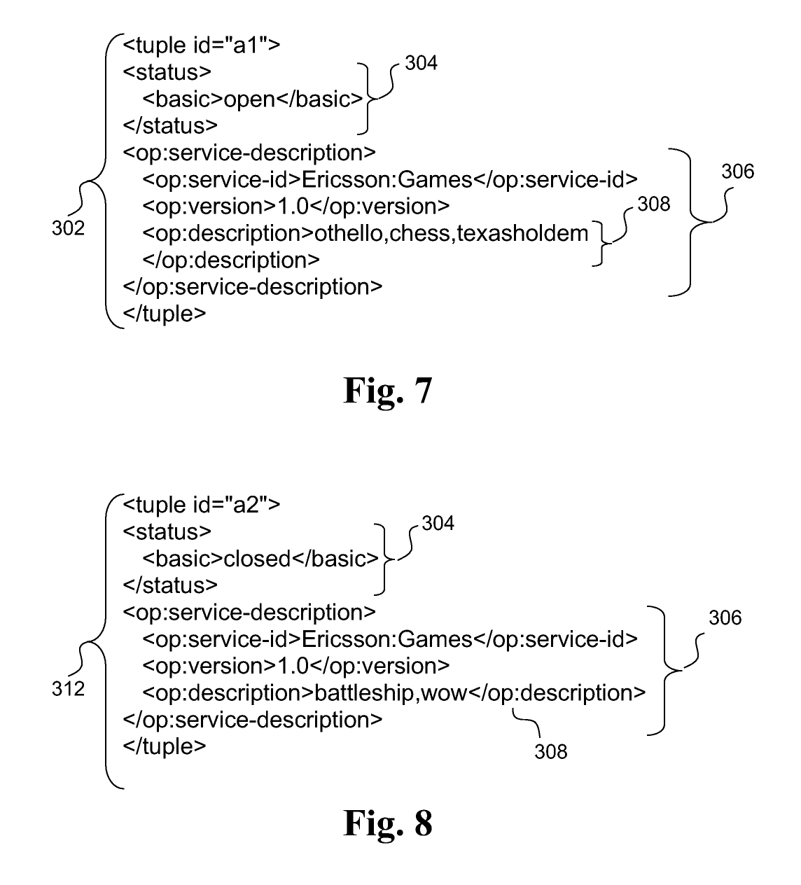

FIGS. 7-10 show exemplary service elements or tuples “a1”-“a4” illustrating different ways of providing information identifying the plurality of services according to the present invention.

In FIG. 7, the service element 302 has metadata 304 comprising status=open. The three services in question, namely the games “othello”, “chess”, and “texasholdem”, are included in a description element 308 of a service description element 306.

In FIG. 8, the service element 312 has metadata 304 comprising status=closed. The two services in question, namely the games “battleship” and “wow”, are included in a description element 308 of a service description element 306.

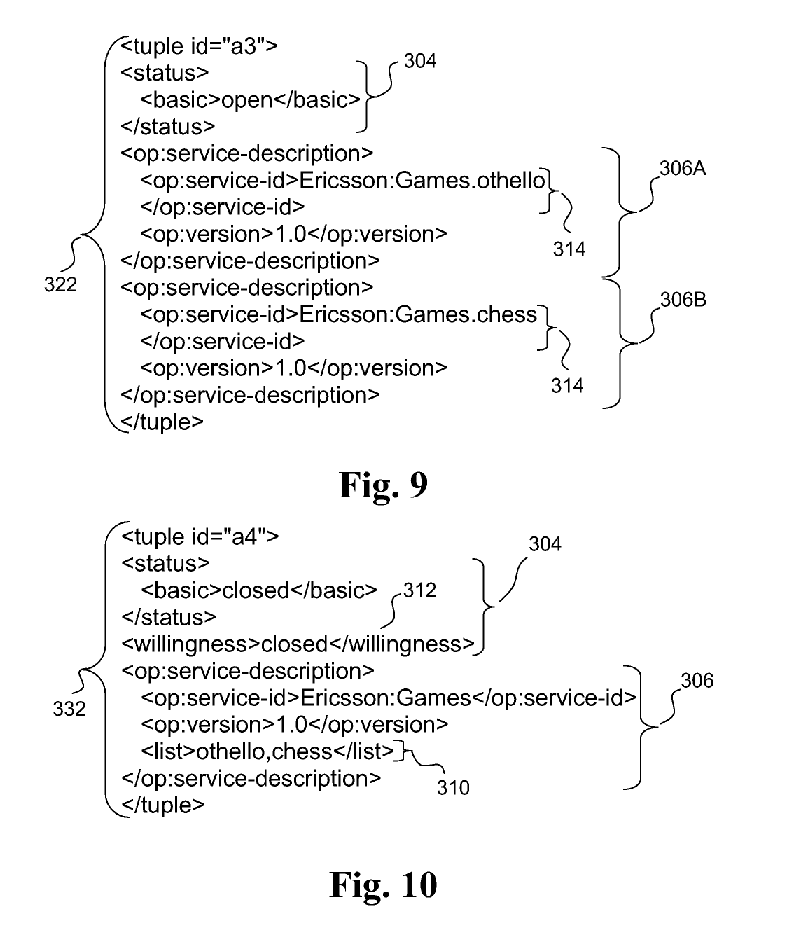

In FIG. 9 the service element 322 has metadata 304 comprising status=open. The two services “othello” and “chess” are included in a service-id element 314 of respective service description elements 306A and 306B.

In FIG. 10 the service element 332 has metadata 304 comprising status=open and willingness=open 312. The two services in question, namely the games “othello” and “chess”, are included in a list element 310 within the service description element 306.

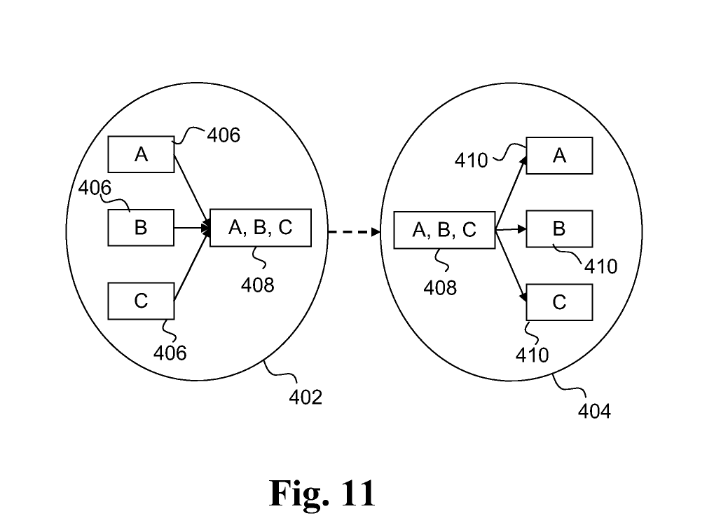

FIG. 11 illustrates updating of presence information between entities 402, 404 according to the invention. A first entity 402 comprises a processor that is adapted to select or identify a plurality of services to be updated, in the illustrated case the services A, B and C, the services having at least partly overlapping metadata. Each service A, B, and C may have separate service elements 406 from which the first entity 402 is adapted to identify services having common metadata. The first entity 402 is further adapted to provide a service element 408 comprising the common metadata and information about the three services A, B, and C. The service elements may take any suitable form as describe above, e.g. one of the forms 302, 312, 322 or 332 or a combination of these. Finally, the first entity is adapted to send the service element 408 to the second entity 404, which in turn is adapted to receive the service element 408 comprising the metadata to be updated. Furthermore the second entity is adapted for handling and updating presence information 410 for each of the services A, B and C based on the single received service element 408. The first entity 402 may be embodied e.g. as a Presence Server 103, a Presence Source 104, a PS XDMS 110, a RLS 112 or a RLS XDMS 114. The second entity 404 may be embodied e.g. as a Presence Server 103, a Presence Watcher 106, a PS XDMS 110, a RLS 112 or a RLS XDMS 114.

The service element may be provided in a presence XML document.

The present invention has been illustrated with two or three services. However the present invention is not limited in the number of services to be handled by one single service element. On the contrary, the more services that can be put into one service element, the larger reduction in amount of signaling between the entities in the network which consequently leads to a more efficient utilization of signaling capacity, in particular within a mobile network where signaling capacity is often a limited resource.

An example of use of the present invention is for simple games where a user may have a large number of small games available on his mobile terminal and all of these different games or services have the same type of metadata which are often identical. Often the only difference between the metadata is that the user either is available for the game or not. The present invention provides such services to be updated with one single service element leading to reduced amount of data to be transmitted in the network.

One or more types of metadata may be updated within a single service element. In an embodiment of the present invention one type of metadata is updated in one service element and the method is repeated for another type of metadata that is updated in another service element, e.g. for a part of the services updated in the first run.

It should be noted that in addition to the exemplary embodiments of the invention shown in the accompanying drawings, the invention may be embodied in different forms and should not be construed as limited to the embodiments set forth herein. Rather, these embodiments are provided so that this disclosure will be thorough and complete, and will fully convey the concept of the invention to those skilled in the art.

1. A method for updating presence information in a communication network comprising a first entity and a second entity, the method comprising the steps of:
a. selecting a plurality of services,
b. providing a service element comprising metadata of the plurality of services,
c. providing information within the service element, wherein the information identifies the plurality of services, and
d. sending the service element to the second entity.

2. The method according to claim 1, wherein the step of selecting a plurality of services comprises selecting a plurality of services having common metadata.

3. The method according to claim 1, wherein the step of providing information within the service element comprises providing at least one service description element, each service description element comprising at least one service of the plurality of services.

4. The method according to claim 3, wherein the at least one service description element comprises a description element identifying one or more services of the plurality of services.

5. The method according to claim 3, wherein the at least one service description element comprises a list element identifying one or more services of the plurality of services.

6. The method according to claim 2, wherein the metadata comprises a status element.

7. The method according to claim 2, wherein the metadata comprises a willingness element

8. An entity for a communication network, wherein the entity is adapted for selecting a plurality of services, adapted for providing a service element comprising metadata of the plurality of services, adapted for providing information within the service element, wherein the information identifies the plurality of services, and adapted for sending the service element to another entity in the communication network.

9. The entity according to claim 8, wherein the entity is adapted for selecting a plurality of services having common metadata.

10. The entity according to claim 8, wherein the entity is adapted for providing at least one service description element within the service element, each service description element comprising at least one service of the plurality of services.

11. The entity according to claim 10, wherein the at least one service description element comprises a description element identifying one or more services of the plurality of services.

12. The entity according to claim 10, wherein the at least one service description element comprises a list element (310) identifying one or more services of the plurality of services.

13. The entity according to claim 8, wherein the entity is a Presence Server.

14. The entity according to claim 8, wherein the entity is a Presence Source.

15. The entity according to claim 8, wherein the metadata comprises a status element.

16. The entity according to claim 8, wherein the metadata comprises a willing ness element.

17. An entity for a communication network, wherein the entity is adapted for receiving a service element comprising metadata of a plurality of services, and adapted for updating metadata of each of the plurality of services based on the received service element.

18. A computer program product for updating presence information in a communication network comprising a first entity and a second entity, the computer program product comprising:
a. computer program code which, when run on a computer, can select a plurality of services,
b. computer program code which, when run on a computer, can provide a service element comprising metadata of the plurality of services,
c. computer program code which, when run on a computer, can provide information within the service element, wherein the information identifies the plurality of services, and
d. computer program code which, when run on a computer, can send the service element to the second entity.
